(19) United States
(12) Patent Application Publication
(10) Pub. No.: US 2005/0235279 A1
(43) Pub. Date: Oct. 20, 2005

(54) METHOD OF UPDATING SOFTWARE IN A HOST-CLIENT NETWORK

(76) Inventor: Heng-Chien CHEN, Taipei City (TW)

Correspondence Address: NORTH AMERICA INTELLECTUAL PROPERTY CORPORATION, P.O. BOX 506, MERRIFIELD, VA, 22116, US

(21) Appl. No.: 10/709,104

(22) Filed: Apr. 14, 2004

(51) Int. Cl. G06F 9/44

(52) U.S. Cl. 717/172

(57) ABSTRACT

A method for updating software in a plurality of clients connected to a host through a network includes connecting an updating device to the host, the updating device storing updated software to be used for updating software stored in the clients. Next, communication is initiated between the updating device and the host, and the updating device transmits the updated software to the host. The host then uploads the updated software to each of the clients for replacing previous versions of software stored in the clients with the updated software.

### BACKGROUND OF INVENTION

1. Field of the Invention

The present invention relates to a host-client network, and more specifically, to a method of updating software or system information in each client of a host-client network.

2. Description of the Prior Art

A host-client network often contains a large number of clients connected to a host through a network. The number of clients connected to the host can vary widely, but the principles of how the network operates remain the same. The clients may be connected to the host locally or remotely. For instance, clients that are connected to the host remotely may be connected to the host through the Internet.

Unfortunately, it is often necessary to update software or system information on each client in the host-client network. Updating software in a local network is convenient using functions of a Local Area Network (LAN). However, for remote clients connected to the host through the Internet, the process of updating software is much more difficult.

There are three main choices for updating software on remote clients. First of all, the software can be replaced on each client manually. For example, new software can be installed on a client by a technician trained to work on the client, or the user of the client can install the new software. This process is slow and has to be repeated for each client in the network, thereby requiring a great deal of time to update all of the clients.

Second, a user of each client can download the new software through the Internet and install the software on the client. This eliminates the need to physically carry the software to each client. Unfortunately, the process of manually installing downloaded software is also slow and time consuming since it has to be repeated for each client.

A third choice is to replace the client with a new client having updated software. Although this may be more expensive than upgrading the software of the client, buying a new client is often times more convenient than having to upgrade the client. This is especially true if the cost of the client is comparable to the cost of the software upgrade, such as when the client is an inexpensive embedded product.

### SUMMARY OF INVENTION

It is therefore an objective of the claimed invention to provide a method of updating software in a plurality of clients for solving the above-mentioned problems.

According to the claimed invention, a method for updating software in a plurality of clients connected to a host through a network is proposed. The method includes connecting an updating device to the host, the updating device storing updated software to be used for updating software stored in the clients. Next, communication is initiated between the updating device and the host, and the updating device transmits the updated software to the host. The host then uploads the updated software to each of the clients for replacing previous versions of software stored in the clients with the updated software.

It is an advantage of the claimed invention that the software in each of the clients can be updated quickly and with minimal effort. Even if the clients are remotely connected to the host through the Internet, the software on the clients can still be updated without having to manually upgrade the software on each client.

These and other objectives of the claimed invention will no doubt become obvious to those of ordinary skill in the art after reading the following detailed description of the preferred embodiment, which is illustrated in the various figures and drawings.

### BRIEF DESCRIPTION OF DRAWINGS

FIG. 1 is a diagram of a host-client network according to the present invention.

### DETAILED DESCRIPTION

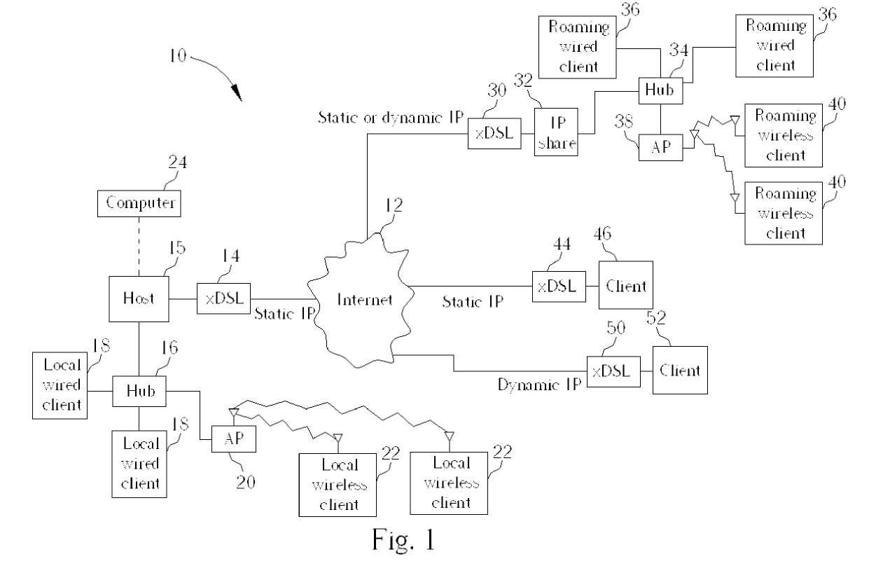

Please refer to FIG. 1. FIG. 1 is a diagram of a host-client network 10 according to the present invention. A host 15 is connected to the Internet 12 through an Internet connection 14. The Internet connection 14 may be an xDSL connection or another suitable broadband Internet connection. The Internet connection 14 provides a static IP address to the host 15, which ensures that the host 15 can always be located by other components in the host-client network 10. A plurality of local wired clients 18 are connected to the host 15 through a hub 16. In addition, an access point 20 is connected to the hub 16 for wirelessly connecting a plurality of local wireless clients 22 to the host 15. The local wired clients 18 and the local wireless clients 22 are said to be connected to the host 15 locally since they connect to the host 15 locally instead of through the Internet 12.

Additional clients are also connected to the host 15 remotely. All remote clients can connect to the host-client network 10 through either a static IP address or a dynamic IP address. For example, another Internet connection 30 can provide either a static IP or dynamic IP address. An IP sharing device 32 and a hub 34 are connected to the Internet connection 30, and are used to share the Internet connection 30 with each device connected to the hub 34. A plurality of roaming wired clients 36 are connected to the host-client network 10 through the hub 34. Additionally, an access point 38 is also connected to the hub 34 for wirelessly connecting a plurality of roaming wireless clients 40 to the host-client network 10.

As another example, clients 46 and 52 can also be connected to the host-client network 10 through direct connections to Internet connections 44 and 50, respectively. For illustrating the possibilities of connecting clients to the host-client network 10, the Internet connection 44 provides a static IP address whereas the Internet connection 50 provides a dynamic IP address. The clients in the host-client network 10 can be Internet appliances, Internet telephones, or any kind of device that can connect to the host 15 through the Internet 12.

For upgrading software or system information in each client of the host-client network 10, the present invention method connects an upgrading device such as a computer 24 to the host 15. First of all, the computer 24 is connected to the host 15. The computer 24 contains updated software that is to be used for upgrading the software of the clients in the host-client network 10. Please note that updated system information can also be sent instead of or in addition to the updated software. After being connected to the host 15, the computer 24 sends a request to the host 15 asking to send the updated software to the host 15. The host 15 then grants the request, and the computer 24 transmits the updated software to the host 15. The host 15 stores the updated software received from the computer 24 in a buffer, and will copy the updated software from the buffer when sending the updated software to each client in the host-client network 10.

The host 15 then determines an order in which to send the updated software to each of the clients. To update as many clients in as short of time as possible, the host 15 will sort the clients in order of decreasing connection speed between the respective clients and the host 15. That is, those clients that have the fastest connection speed with the host 15 will be sent the updated software before the clients with a slower connection speed. Of course, the host 15 can also sort the clients according to different criteria when deciding what order to send the updated software to the clients. Once the order has been determined by the host 15, the host 15 can inform the computer 24 of the order in which the updated software will be sent to the clients.

Next, the host 15 transmits the updated software to each of the clients in the determined order. Each of the clients will check whether the updated software was successfully received, and will report the result to the host 15. For each client, if the client has successfully received the updated software, the host 15 will command the client to replace the previous version of software stored in the client with the updated software. On the other hand, if the client has not successfully received the updated software, the host 15 will resend the updated software to the client. While the host 15 is sending the updated software to the clients, the host 15 will keep the computer 24 informed about the update status and the progress made during the uploading process.

After the updated software is successfully stored on the clients, the host 15 commands the clients to reboot and to reconnect to the host 15 via the host-client network 10. Next, the host 15 notifies the computer 24 that the software update is complete.

In summary, the present invention method provides a quick and simple way to update the software or system information on a number of clients connected to the host. The present invention method is particularly valuable for updating the software on clients remotely connected to the host through the Internet. The present invention eliminates the need to manually update the software on remote clients, thereby saving time and resources needed to complete the update.

Those skilled in the art will readily observe that numerous modifications and alterations of the device may be made while retaining the teachings of the invention. Accordingly, the above disclosure should be construed as limited only by the metes and bounds of the appended claims.

1. A method for updating software in a plurality of clients connected to a host through a network, the method comprising:
connecting an updating device to the host, the updating device storing updated software to be used for updating software stored in the clients;
initiating communication between the updating device and the host;
transmitting the updated software from the updating device to the host; and
the host uploading the updated software to each of the clients for replacing previous versions of software stored in the clients with the updated software.

2. The method of claim 1 wherein initiating communication between the updating device and the host comprises the updating device requesting to send updated software to the host and the host granting the updating device's request to send the updated software.

3. The method of claim 1 wherein before transmitting the updated software from the updating device to the host, the host determines an order in which to upload the updated software to the clients.

4. The method of claim 3 wherein the host calculates the connection speed between the host and each of the clients, and sorts the clients in order of decreasing connection speed for determining the order in which to upload the updated software to the clients.

5. The method of claim 3 wherein before uploading the updated software to the clients, the host informs the updating device of the order in which the host will upload the software to the clients.

6. The method of claim 1 further comprising the host informing the updating device about progress made with the uploading process while the host is uploading the updated software to the clients.

7. The method of claim 1 further comprising the host notifying the updating device that the update is complete after the host has finished uploading the updated software to each of the clients.

8. The method of claim 1 wherein the host uploading the updated software to each of the clients comprises:
the host transmitting the updated software to each client;
the client checking that the updated software was successfully received and reporting the result to the host;
the host commanding the client to replace the previous version of software stored in the client with the updated software if the client has successfully received the updated software; and
the host commanding the client to reboot and reconnect to the host.

9. The method of claim 8 wherein if the client has not successfully received the updated software, the host resends the updated software to the client.

10. The method of claim 1 wherein when the updating device transmits the updated software to the host, the host stores the updated software in a buffer before uploading the updated software to the clients.

11. The method of claim 1 wherein the clients are remotely connected to the host through the Internet.

12. The method of claim 1 wherein the clients are locally connected to the host through a local network.

13. The method of claim 1 wherein the updating device is a computer.

14. A method for updating software in a plurality of clients connected to a host through a network, the method comprising:
connecting an updating device to the host, the updating device storing updated software to be used for updating software stored in the clients;
the updating device requesting to send updated software to the host;
the host granting the updating device's request to send the updated software;
transmitting the updated software from the updating device to the host;
the host calculating the connection speed between the host and each of the clients;
the host sorting the clients in order of decreasing connection speed for determining the order in which to upload the updated software to the clients;
the host informing the updating device of the order in which the host will upload the software to the clients;
the host transmitting the updated software to each client in the determined order;
the clients checking that the updated software was successfully received and reporting the result to the host;
the host commanding the clients to replace the previous version of software stored in the clients with the updated software if the clients have successfully received the updated software; and
the host commanding the clients to reboot and reconnect to the host.

15. The method of claim 14 further comprising the host notifying the updating device that the update is complete after the host has finished uploading the updated software to each of the clients.

16. The method of claim 14 further comprising the host informing the updating device about progress made with the uploading process while the host is uploading the updated software to the clients.

17. The method of claim 14 wherein if the client has not successfully received the updated software, the host resends the updated software to the client.

18. The method of claim 14 wherein when the updating device transmits the updated software to the host, the host stores the updated software in a buffer before uploading the updated software to the clients.

19. The method of claim 14 wherein the clients are remotely connected to the host through the Internet or through a local network.

20. The method of claim 14 wherein the updating device is a computer.
